(19) United States
(12) Patent Application Publication
(10) Pub. No.: US 2010/0042912 A1
(43) Pub. Date: Feb. 18, 2010

(54) REMINDER AND NOTIFICATION SYSTEM FOR A PARENT

(76) Inventor: Eva Whitaker, Atlanta, GA (US)

Correspondence Address: Steven L. Schmid, 1824 Hickory Trace Dr., Fleming Island, FL, 32003, US

(21) Appl. No.: 12/483,186

(22) Filed: Jun. 11, 2009

Related U.S. Application Data
(60) Provisional application No. 61/060,859, filed on Jun. 12, 2008.

(51) Int. Cl. G06F 15/16; G06F 17/00

(52) U.S. Cl. 715/212; 709/203; 709/206

(57) ABSTRACT

Disclosed is a web-based system for providing reminders to mothers for organizing life events. The system provides cues to mothers in a web based application which may be sent via email. The cues may include various checklists and spreadsheets customized to meet the needs of mothers. The system further includes a method of delivering target advertisements and a web-based community.

### RELATED APPLICATION

This application relies upon U.S. Provisional Application Ser. No. 61/060,859 filed Jun. 12, 2008, the content of which is hereby incorporated in its entirety.

### TECHNICAL FIELD

The present invention relates to a method of providing a system for scheduling and reminding a user regarding certain events and in greater detail the method relates to providing reminders to a parent in a web enabled environment.

### BACKGROUND

Modern technology has produced both devices that save time and devices that demand more of our time. The computer has increased productivity by reducing the amount time to create documents, analyze data, and to communicate work product to others via vast networks. The Internet and spread of wireless technologies has made it possible for individuals separated by vast distances to stay “connected.” Whatever time savings technology may have conferred have seemingly been lost due to the increased demands that flow from being accessible at any time from anywhere on the planet.

Managing time has thus become an import part of modern life. Time management tools may be designed to keep track of how time has been committed and/or to keep track of how time was used. Examples of time-commitment systems include electronic calendars and day planners. Time-spent systems can be viewed as electronic diaries or journals. The data entry process is thus time consuming and the data in free form and not easily analyzed or represented analytically. This raises the question of whether the data collected using the time management tool has sufficient value to justify the time spent acquiring the collected data.

To the extent that currently available time management tools capture time usage, they do not provide for goal/target setting and performance monitoring and do not serve as goal and life planning/management tools.

Additionally, parents and especially mothers have very busy schedules that do not lend themselves to conventional time management applications. Most applications require users to setup schedules based upon the general needs of the business community and lack a needed focus directed to a particular group such as mothers. Furthermore, the known art does not provide scheduled suggestions for organizing one's day, week or month.

What would be useful, therefore, is a system for providing reminders to a customized target audience such as mothers wherein the audience's needs are prioritized. It would also be advantageous to have a web-based system portable across a wide variety of platforms providing reminders to the target audience. Furthermore, what is needed is a system directed to the target audience providing checklists and spreadsheets for various tasks commonly performed by the target audience.

### SUMMARY

The present method of providing reminders to a customized audience includes a web-based system providing cues to parents in helping organize their lives. The reminders may be sent automatically to a user via email and may include various checklists and spreadsheets customized to meet the needs of parents. Furthermore, via a reminder prompting exercise the system is able to help parents organize their activities and remind them of many things often forgotten during a busy day. The system also provides a means for advertising to a targeted audience and a web-based community of like minded individuals.

In greater detail the present system includes a web-based reminder and notification system directed to a parent providing goal setting and performance monitoring cues. The system includes a server housing a program for providing cues in the reminder and notification system for the parent. The system further includes a computing device operately connected to the server. The server communicates with the computing device for providing cues to the parent via the computing device. The cues may be reminders of events, goals or performance monitoring indicators.

The computing device may be a computer, smart phone, cell phone, net book, laptop, and combinations thereof. Essentially, the computing device is most any device capable of connecting to the internet. The cues or reminders may be provided to the parent via an email message, text message or similar method.

In a further embodiment the system includes parentally directed reminders sent to a third party. For example a parent may desire to send a reminder to a nanny or other care giver to remind the person of child's event or medication. Essentially, the third party may be the children of the parent, caregivers, spouses or any combinations thereof.

The system further provides for advertisements directed to the parent using the system. Given the unique group of the present system advertisers are essentially guaranteed a very specific and targeted audience.

Additionally the system includes providing an existing list of reminders whereby the parent is asked to choose desired reminders from a list. The previously generated list comprises items often needed by parents. The same is true for the pre-provided checklists directed to parents whereby the parent selects a desired checklist.

Spreadsheets are also provided in an embodiment for meal planning. The meal planning spreadsheets include groups for meals planned, recipes, dinners and combinations thereof. A shopping spreadsheet list is also provided and may include items selected from the group consisting of groceries, gifts, stores frequented, and combinations thereof. Spreadsheets for daily activities are also included for such maters as appointments and reminders.

### DRAWINGS

In the drawings:

FIG. 1 is an example of an email delivered to a mother under the present system providing a weekly schedule of activities needed to be done for a particular week and a sample advisement targeted to a parent;

FIG. 2 is an illustration of a web-based landing page for use when a user needs to edit a weekly schedule or reminder;

FIG. 3 depicts a sample spreadsheet for use with the present system;

FIG. 4 is a web-page view of the meal planning heading under menus showing planned meals;

FIG. 5 illustrates a spreadsheet of daily activities including appointments, personal reminders and professional reminders;

FIG. 6 depicts a spreadsheet of weekly activities; and

FIG. 7 is a web-page view of the shopping heading with the subcategory of lists wherein grocery lists and item lists are displayed in this embodiment.

### DETAILED DESCRIPTION

Disclosed is a web-based system for providing reminders to a customized audience to aid in organizing one's day, week, month or year. The system typically provides cues to parents in a web based application including targeted advertisements for mothers providing a revenue stream. The reminders or cues may be sent automatically to the parent via email.

The cues or reminders may further be comprised of various checklists and spreadsheets customized to meet the needs of mothers for organizing their activities and common events often forgotten during a mother's busy day. The system also provides a web based community where mothers can discuss their day and provide support for other mothers. The terms “cues” and “reminders” are used interchangeably herein and are both intended to encompass the generally meanings of both terms and as they are used herein.

In greater detail the present system includes an introduction accessed via the web explaining the concept of the system and how the system provides a simple way for busy parents to stay organized. The parent in the present system after being introduced to the system can be led through a brief exercise where she will be asked to check off from an existing list of “reminders” she may want included in her program. Once the parent has selected the desired reminders, she can be provided the opportunity to create her own reminders to further customize her program. Furthermore, the parent may click through each chosen reminder to complete more details about her reminders.

Additionally, the system includes several templates of various checklists and spreadsheets which can be customized, saved, and used repeatedly by the user. For example, the system includes a “Nanny's Work Sheet” which a parent can update each week, print, and give to her nanny. The parent can program the “Nanny's Work Sheet” to automatically be emailed to her with her reminder to “Give Nanny her Work Sheet”. The parent can create an account and select the format she wants her reminders on a monthly, weekly, or daily basis.

The parent may begin receiving reminders on whatever day and in whatever format she has built into her program. The parent may update or edit her reminders at anytime on the website or web-based interface. Furthermore, a “community” is created on the web-based system where parents can offer ideas for reminders, checklists and spreadsheets that others may use. Also, marketers can directly access a target market at the exact time the parent has said she needs to be reminded. For example, “Give pet flea and heartworm medication” is a great opportunity for a pet supply company to advertise.

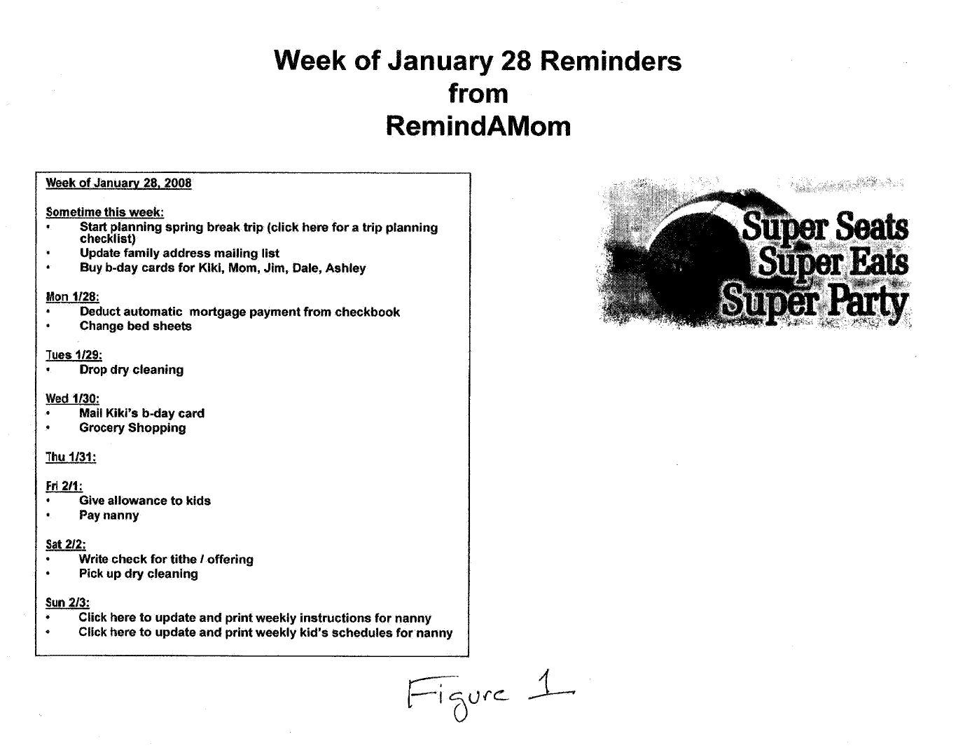

FIG. 1 is an example email reminder sent to a mother under the present system. The reminders may be sent as weekly reminder schedules or simply sent as reminders for certain events or happenings. In the present illustration the reminder is a weekly schedule of various activates needed to be done for a particular week. Also included in the reminder is a target advertisement which may be linked to certain events specified in the reminder.

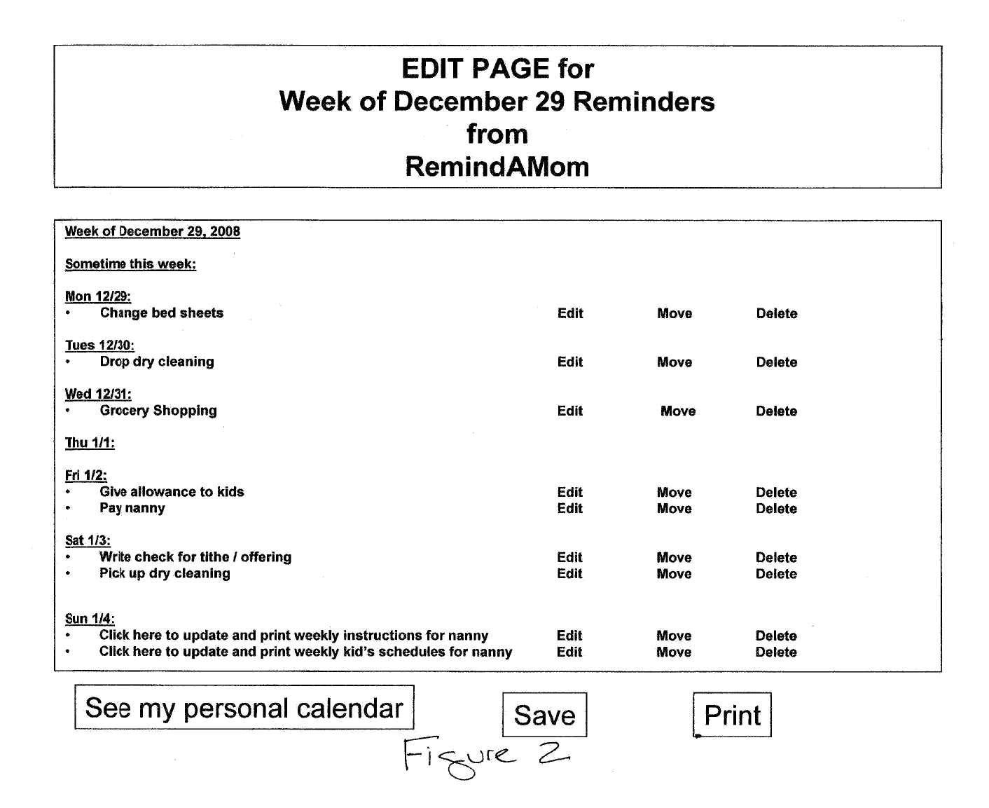

As shown in FIG. 2, there is depicted a sample landing page in the present web-based reminder system for a mother. The landing page enables a mother to edit or change the text of a reminder. Furthermore, the mother can move a reminder by simply clicking on the monthly calendar to move over the reminder to another week or day. Additionally, if the mother needs to delete a reminder, them she can choose if the removal is only for a certain week or if the removal permanent. If the removal is permanent, the reminder is removed from all its scheduled appearances. Furthermore, the system prompts the user with the option to both save the changes and print the newly revised schedule.

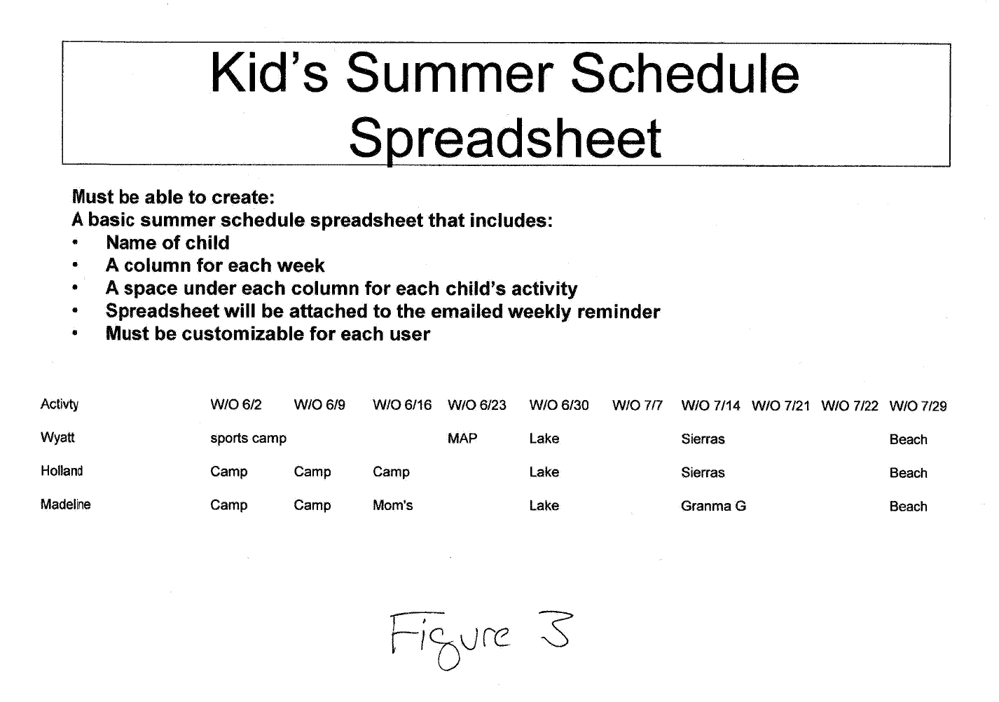

FIG. 3 depicts an example spreadsheet which can be generated by the present system for aiding in organizing a mother's activities. The spreadsheets and checklists are customized to meets the needs of the mother and include activities typically encountered by a mother. The example illustrated in FIG. 3 depicts a child's summer schedule with the child's weekly activities noted. The illustration further includes an explanation of the basics needed for a summer schedule. The spreadsheet may be attached to the weekly emailed reminder forwarded to the mother and may be customized by the mother by entering the required information such as the child's name. Typically, the spreadsheets and checklists are customized and edited when used.

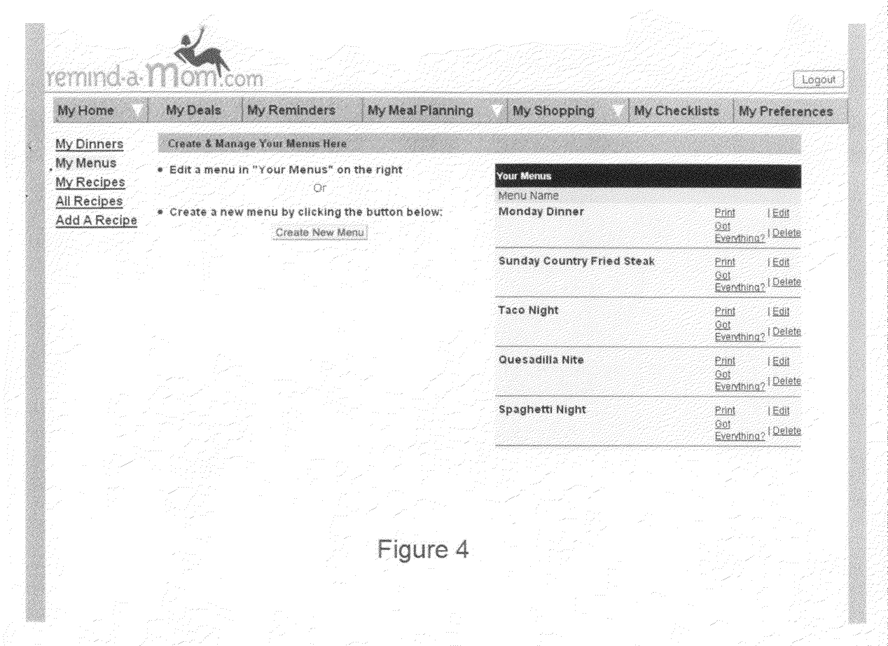

As depicted in FIG. 4 there is a web-page view of the meal planning heading under menus showing planned meals. The meal planning heading may include meals planned including menus for a specific day or in general such as illustrated in the “Taco Night” entry. Furthermore recipes may also be included under this heading. Recipes may be further associated with days in a meal panning event.

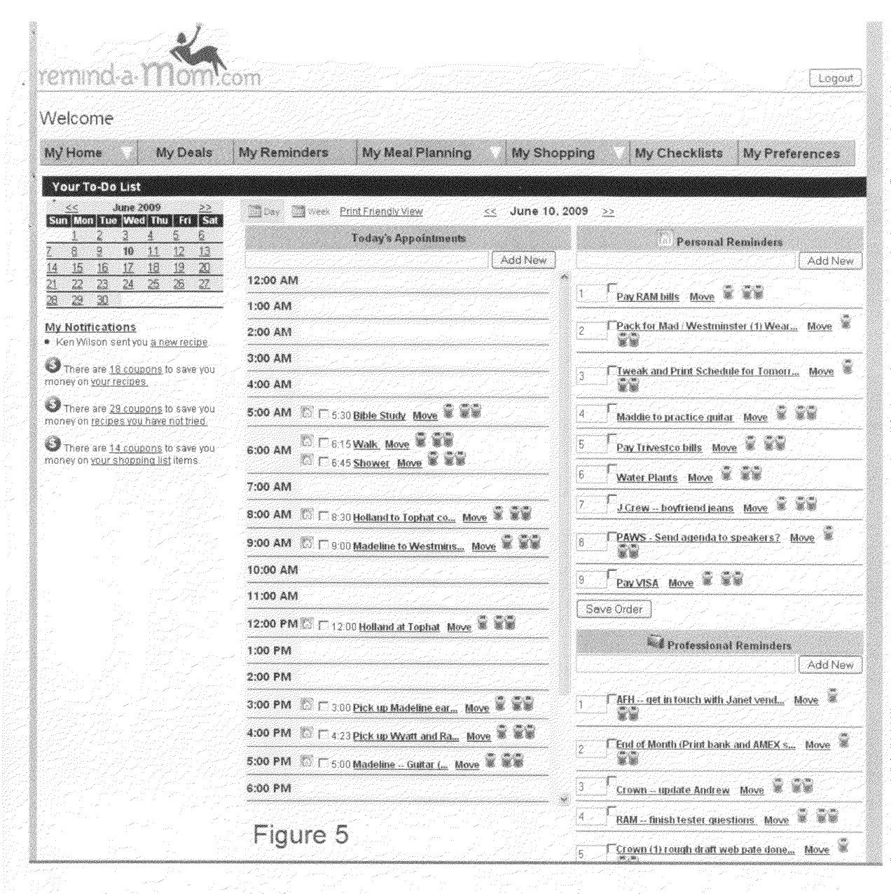

FIG. 5 illustrates a spreadsheet of daily activities including appointments, personal reminders and professional reminders. In the illustrated embodiment the daily activities are listed under the “my home” heading but may be placed under most general heading if desired in a further embodiment. The daily activities include appointments, personal reminders and professional reminders which can have reminders associated with each.

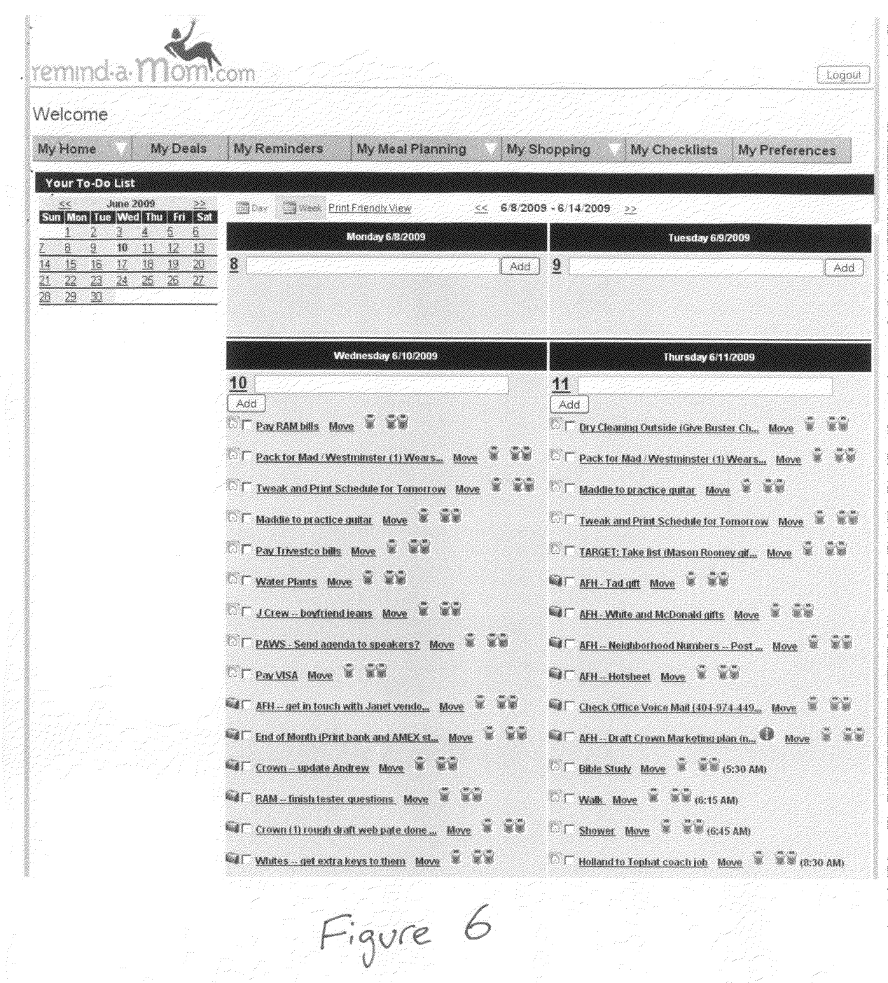

FIG. 6 depicts a spreadsheet of weekly activities associated with the calendar to the left of the illustrated spreadsheet. In this embodiment a parent is presented with a quick daily list of activities of each day for the week. Reminders may also be associated with each of the activities listed.

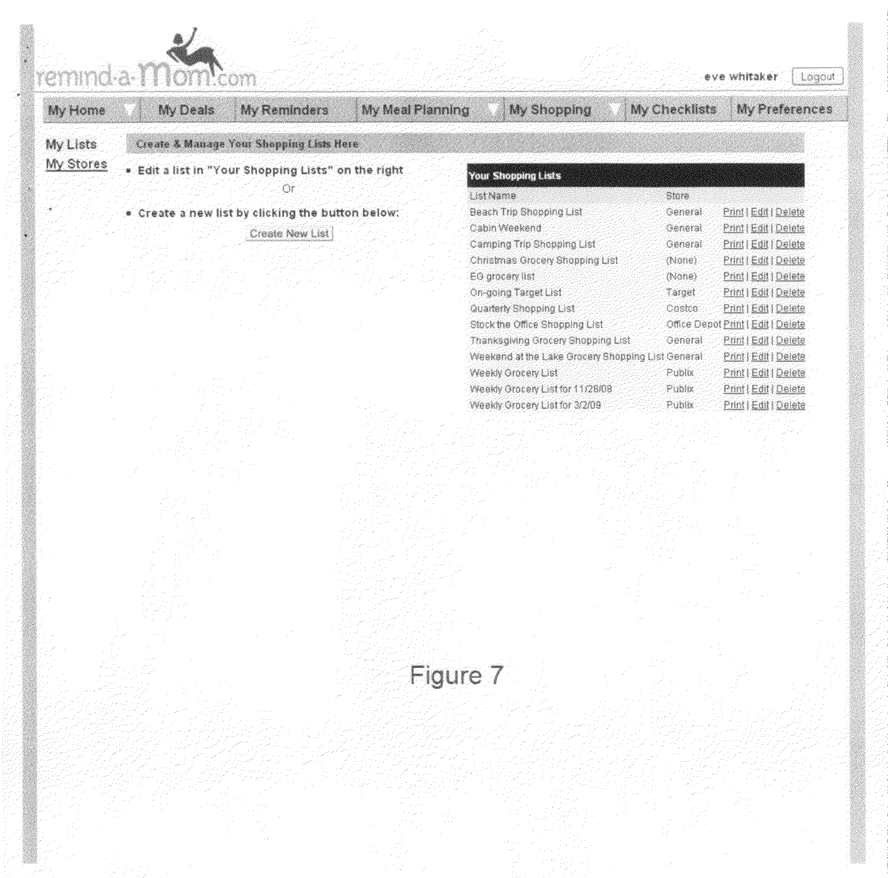

FIG. 7 is a web-page view of the “shopping” heading with the subcategory of lists shown. The other subcategory includes stores frequented by the parent and lists may be associated with certain stores. Under this heading are subcategory lists such lists as those for groceries and item lists as depicted in the illustrated embodiment. Of course various lists may also be associated with certain reminders or cues.

While applicants have set forth embodiments as illustrated and described above, it is recognized that variations may be made with respect to disclosed embodiments. Therefore, while the invention has been disclosed in various forms only, it will be obvious to those skilled in the art that many additions, deletions and modifications can be made without departing from the spirit and scope of this invention, and no undue limits should be imposed except as set forth in the following claims.

What is claimed is:

1. A web-based reminder and notification system directed to a parent providing goal setting and performance monitoring cues comprising:
a server housing a program for providing cues in the reminder and notification system for the parent;
a computing device operately connected to the server; and
the server communicating with the computing device providing cues to the parent via the computing device.

2. The system of claim 1, wherein the computing device is selected from the group consisting of a computer, smart phone, cell phone, net book, laptop, and combinations thereof.

3. The system of claim 1, wherein the reminders are provider to the parent via email.

4. The system of claim 1, further including parentally directed reminders sent to a third party.

5. The system of claim 4, wherein the third party is selected from the group consisting of children of the parent, caregivers, spouses and combinations thereof.

6. The system of claim 1, further including presenting advertisements to the parent using the system.

7. The system of claim 1, further including the system providing an existing list of reminders whereby the parent is asked to choose desired reminders from the list.

8. The system of claim 1, further including providing checklists directed to parents whereby the parent selects a desired checklist.

9. The system of claim 1, further including a meal planning spreadsheet, the spreadsheet including items selected from the group consisting of meals planned, recipes, dinners and combinations thereof.

10. The system of claim 1, further including providing a shopping spreadsheet list.

11. The system of claim 10, wherein the shopping spreadsheet comprises items selected from the group consisting of groceries, gifts, stores frequented, and combinations thereof.

12. The system of claim 1, further including a spreadsheet of daily activities.

13. The system of claim 12, wherein the spreadsheet of daily activities includes events selected from the group comprising appointments, reminders and combinations thereof.

14. A reminder and notification system directed to a parent providing goal setting and performance monitoring cues comprising:
a server housing a program for providing cues in the reminder and notification system for the parent;
the program including a spreadsheet of daily activities including appointments and reminders, the program also providing a list of existing reminders whereby the parent is asked to choose desired reminders from the list, the program further providing checklists directed to the parent whereby the parent selects a desired checklist;
a computing device selected from the group consisting of a computer, smart phone, cell phone, net book, laptop, and combinations thereof, the computing device operately connected to the server; and
the server communicating with the computing device and providing cues to the parent via the computing device.

15. The system of claim 14, further including parentally directed reminders sent to a third party wherein the third party is selected from the group consisting of children of the parent, caregivers, spouses and combinations thereof.

16. The system of claim 14, further including presenting advertisements to the parent using the system.

17. The system of claim 14, further including a meal planning spreadsheet, the spreadsheet including items selected from the group consisting of meals planned, recipes, dinners and combinations thereof.

18. The system of claim 14, further including providing a shopping spreadsheet list wherein the shopping spreadsheet comprises items selected from the group consisting of groceries, gifts, stores frequented, and combinations thereof.

19. A reminder and notification system directed to a parent providing goal setting and performance monitoring comprising:
a server housing a program for providing the reminder and notification system for the parent;
the program including a spreadsheet of daily activities including appointments and reminder and a list of existing reminders whereby the parent is asked to choose desired reminders from the list, the program further providing checklists directed to the parent whereby the parent selects a desired checklist, the program further including spreadsheets directed to meal planning and shopping lists;
a computing device operately connected to the server and the computing device selected from the group consisting of a computer, smart phone, cell phone, net book, laptop, and combinations thereof, the computing device;
the server communicating with the computing device and reminding and notifying the parent via the computing device of an event; and
parentally directed reminders sent to a third party wherein the third party is selected from the group consisting of children of the parent, caregivers, spouses and combinations thereof.

20. The system of claim 19, further including presenting advertisements to the parent using the system.
